(19) United States
(12) Patent Application Publication
(10) Pub. No.: US 2016/0292358 A1
(43) Pub. Date: Oct. 6, 2016

(54) METHOD FOR PREPARING A SYSTEM FOR SEARCHING DATABASES AND SYSTEM AND METHOD FOR EXECUTING QUERIES TO A CONNECTED DATA SOURCE

(71) Applicant: AGFA HEALTHCARE GMBH, Bonn (DE)

(72) Inventor: Oliver HEGER, Mortsel (BE)

(21) Appl. No.: 15/035,344

(22) PCT Filed: Nov. 10, 2014
(86) PCT No.: PCT/EP2014/074153

§ 371 Date: May 9, 2016

(30) Foreign Application Priority Data
Nov. 22, 2013 (EP) 13194041.3

(51) Int. Cl. G06F 19/00; G06F 17/30

(52) U.S. Cl. CPC G06F 19/32; G06F 17/30289; G06F 17/30525; G06F 17/3043

(57) ABSTRACT

A system, in particular a medical information system, for executing queries of a connected data source that stores information in an RDF compatible format and uses preset first concepts includes an input that receives a semantic query from a user, wherein the semantic query includes predefined second concepts of a specific user terminology; a processor including a converter that converts the semantic query received from the input into a database query using query language adapted for the RDF compatible format and including the first concepts, and that searches the connected data source by executing the database query; and—an output that outputs the search results retrieved from the connected data source by the processor. It is possible to carry out efficient database searches based on semantic queries using a specific user terminology with reduced processing power and time.

### CROSS-REFERENCE TO RELATED APPLICATIONS

This application is a 371 National Stage Application of PCT/EP2014/074153, filed Nov. 10, 2014. This application claims the benefit of European Application No. 13194041.3, filed Nov. 22, 2013, which is incorporated by reference herein in its entirety.

### BACKGROUND OF THE INVENTION

1. Field of the Invention

The invention relates to a method for preparing a system for searching databases, a system for executing queries to a connected data source, and a method for executing queries to a connected data source, each in particular in a healthcare environment.

2. Description of the Related Art

In the past, information systems used in hospitals used to be mainly billing-driven. Nevertheless, during patient treatment a lot of medical data is collected and stored in these systems. In recent years, however, there has been a transition from hospital information systems for administrative purposes only towards more dedicated clinical information systems to support clinical workflow and decision making. Especially, there has been a trend in making the stored data available for clinical evaluations and to support medical staff at their daily work.

Modern clinical systems strive to provide their users clinical decision support. For instance, they can offer suggestions for an appropriate treatment, analyze new data becoming available for a patient (e.g. lab values) in background based on rules and report anomalies, check user inputs for plausibility, support users entering new data with reasonable default values or data already known to the system, and so on. Further, medical data is not only stored in hospitals but also at general practices, private specialists' practices and other healthcare environments, e.g. homes for the elderly. Many new databases have to be integrated to improve data quality or to provide specific information.

For all of those advanced applications reliable access to a patient's clinical data is crucial. Also, it becomes more and more imperative to connect different databases, not only on individual patient level but also on population level to perform e.g. epidemiologic studies to support policy making. However, data structures in different information systems may differ a lot from each other and may have very complex data structures or models. Thus, the complexity of an implementation is related to the way information can be accessed from the databases used by the respective information system. The complexity of an implementation in turn has an effect on the required processing power and time of the information system.

### SUMMARY OF THE INVENTION

It is an object of the invention to provide an improved concept for executing queries to a connected data source with reduced processing power and time.

This object and other objects are achieved by the methods and systems described below.

A method for preparing a system for searching databases according to a preferred embodiment of the invention comprises the steps of:

analyzing a data structure of a database containing information to be searched;

creating a data source storing the information contained in the database in an RDF compatible format and using first concepts;

analyzing and/or considering a specific user terminology including second concepts;

creating correlations for each second concept with at least one first concept; and

storing the created correlations as annotation data in a memory.

A system for executing queries to a connected data source storing information in an RDF compatible format and using preset first concepts according to a preferred embodiment of the invention comprises:

an inputting means for receiving a semantic query from a user, wherein the semantic query includes predefined second concepts of a specific user terminology;

a processing means comprising a converter module for converting the semantic query received from the inputting means into a database query using query language adapted for the RDF compatible format and including the first concepts, and searching the connected data source by executing the database query; and

an outputting means for outputting the search results retrieved from the connected data source by the processing means.

A method for executing queries to a connected data source storing information in an RDF compatible format and using preset first concepts according to a preferred embodiment of the invention comprises the steps of:

receiving a semantic query from a user, wherein the semantic query includes predefined second concepts of a specific user terminology;

automatically converting the received semantic query into a database query using query language adapted for the RDF compatible format and including the first concepts;

searching the connected data source by executing the database query; and

outputting the search results retrieved from the connected data source.

Preferred embodiments of the invention are based on the approach of creating annotation data and rules correlating concepts of a specific user terminology on the one hand with the data structure and the concepts of databases containing information to be searched on the other hand. To implement this concept of the invention in an efficient way, there are two steps of annotation. First, a data source has to be prepared storing information contained in one or more databases using an RDF compatible format and preset first concepts. Second, the specific user terminology including predefined second concepts has to be analyzed and/or considered for creating correlations for each second concept with at least one first concept to enable an automatic conversion of a semantic query input by a user into a database query to be executed at the prepared data source.

In summary, an efficient way to search databases is presented without a need for the user to know the specific data structure and the specific terminology of the databases to be searched. Based on the two-step annotation process carried out in advance, the information system can execute the semantic queries of a user in a very fast and efficient way. As a result, required processing power and time can be reduced saving energy and time.

The system and methods of the invention can preferably be used in a healthcare environment, like a hospital information system (HIS).

In connection with the present invention, the following abbreviations are used: “RDF” relates to a Resource Description Framework and “SPARQL” relates to a SPARQL Protocol and RDF Query Language.

The database containing information to be searched may be any kind of database using arbitrary data structures, data models and concepts. In the database, data may be stored in an RDF compatible format or not. For example, in a healthcare environment, the database may be part of Agfa HealthCare's clinical information management system named ORBIS®.

The data source created on the basis of the database containing information to be searched may be a physical data source such as a database stored in an information management system, memory disk, a memory stick, etc., or a virtual data source such as a database stored on a web server (e.g. a SPARQL endpoint) etc. In the data source, the information contained in the database are stored in an RDF compatible format or an RDF format using first concepts (or terms or terminology). The RDF compatible format is adapted to be searched by a database query using RDF compatible language.

The specific user terminology is any predefined terminology used by a user of the specific information system. The user terminology uses second concepts (or terms). The specific user terminology is adapted to formulate a semantic query. For example, in a healthcare environment, the user terminology may be some of the well-established standards SNOMED CT, LOINC (Logical Observation Identifiers Names and Codes) or ICD (International Statistical Classification of Diseases and Related Health Problems). The user may be expert staff (e.g. clinical administration personnel, instructed nurses, doctors and pharmacists) or consumers (e.g. patients).

Each predefined second concept of the specific user terminology may be correlated with one or more preset first concepts of the data source.

The inputting means may be a keyboard, a mouse, a touchscreen, etc. preferably being part of a user terminal. The outputting means may be a monitor, a printer, a loudspeaker, etc. preferably being part of a user terminal.

According to a preferred embodiment of the invention, correlations for each second concept with at least one query template including at least one first concept are created and stored as annotation rules in a memory. This preferred embodiment is based on the approach to use special, in particular SPARQL, query templates for assigning concepts from a terminology to data model elements of the information system. As a result, when queried for a specific concept, the query service retrieves the SPARQL templates associated with the concept in question, fills in current parameters, and executes them on the SPARQL endpoint offered by the system (the availability of such a SPARQL endpoint is a preferred pre-condition). This provides an efficient way for storing annotation data which makes the generation of queries on the underlying data structures straight-forward.

According to another preferred embodiment of the invention, data structures of at least two databases including information to be searched are analyzed, and a data source is created storing the information of the at least two databases in an RDF compatible format and using the first concepts. As a result, there is even a reduction in processing power and time for executing queries to a connected data source which is based on two or more databases.

According to another preferred embodiment of the invention, at least two different specific user terminologies including second concepts are analyzed and/or considered. In this way, the database can be searched efficiently by means of two or more different user-specific terminologies.

According to yet another preferred embodiment of the invention, the processing means comprises a memory for storing predefined annotation data which correlate each second concept with at least one first concept and/or a memory for storing predefined annotation rules which correlate each second concept with at least one query template including at least one first concept. In this way, the converting step can preferably use predefined annotation data which correlate each second concept with at least one first concept and/or annotation rules which correlate each second concept with at least one query template including at least one first concept.

According to yet another preferred embodiment of the invention, the processing means comprises a converter module for converting the search results retrieved from the connected data source including the first concepts into a search result format including the second concepts. By this means, the search results are preferably output by using the second concepts, i.e. using the specific user terminology.

Preferably, the system comprises a user terminal including the inputting means and the processing means.

Further, it is preferred that the query language adapted for the RDF compatible format is SPARQL or a SPARQL compatible language.

Further advantages, features and examples of the present invention will be apparent from the following description with reference to the accompanying drawings. In the drawings:

### BRIEF DESCRIPTION OF THE DRAWINGS

FIG. 1 shows a block diagram of an exemplary preferred embodiment of a system for executing queries to a connected data source.

FIG. 2 shows a diagrammatic chart for illustrating the creation of annotation data and rules according to a preferred embodiment of the invention.

FIG. 3 shows a diagrammatic chart for illustrating the process of searching databases according to a preferred embodiment of the invention.

FIG. 4 shows a diagrammatic chart of an exemplary preferred embodiment of a data structure of a database containing information to be searched.

FIG. 5 shows a high-level architecture of a concept query service using ORBIS®.

FIG. 6 shows an illustration for storing annotation data.

### DETAILED DESCRIPTION OF THE PREFERRED EMBODIMENTS

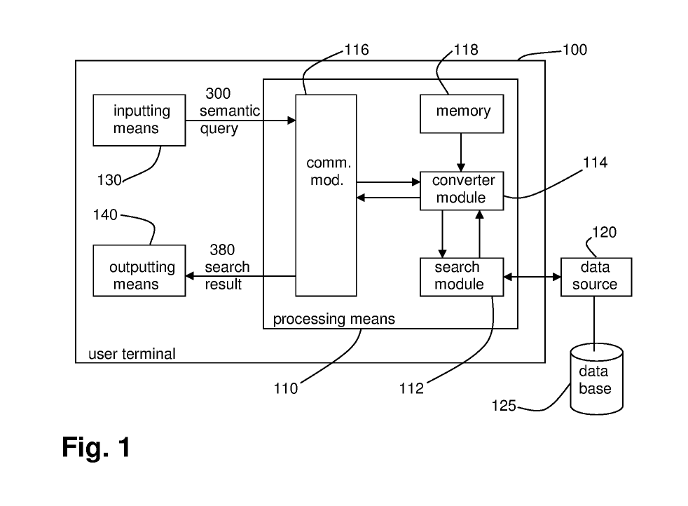

FIG. 1 shows an example of a system for searching databases according to a preferred embodiment of the invention.

The system for searching databases comprises a user terminal 100 which comprises a processing means 110 such as a computer, an inputting means 130 such as a keyboard, and an outputting means 140 such as a monitor and/or a printer. The processing means 110 is connected to a data source 120, e.g. a SPARQL endpoint, storing information in an RDF compatible format and being created on the basis of a database (e.g. ORBIS®)

A user may input a semantic query 300 at the inputting means 130. The semantic query 300 is forwarded to a communication module 116 of the processing means 110. A search result 380 generated by the processing means 110 is forwarded from the communication module 116 to the outputting means 140.

Further, the processing means 110 comprises a search module 112 communicating with the data source 120, a converter module 114 adapted for converting the received semantic query 300 into a database query, and a memory 118 for storing annotation data and annotation rules to be used by the converter module 114.

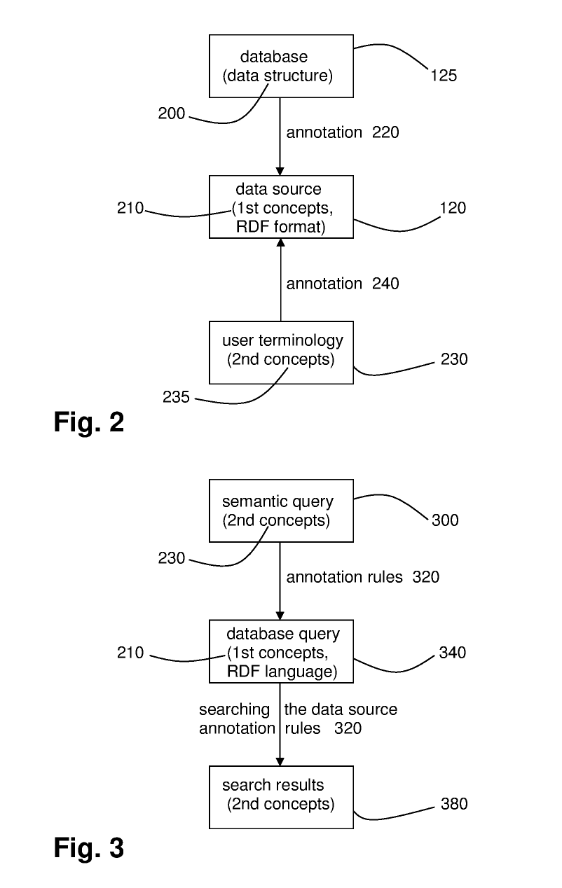

Referring to FIG. 2, the preparation of such a system is explained in more detail. First, the data structure 200 of the database 125 containing information to be searched is analyzed. Then, the data source 120 is created by storing the information contained in the database 125 in an RDF compatible format which can be searched by SPARQL or a SPARQL compatible language and using first concepts 210. For creating the data source 120, an annotation process 220 is carried out correlating the data structure 200 of the database 125 with the RDF format and the first concepts 210 of the data source 120.

Due to the inherent structure of SPARQL, the data is described in terms of classes and properties. The annotation process 220 for implementing the data source 120 has to provide a mapping from elements of the data structure 200 of the database 125 to the classes and properties in the data structure of the data source 120. This can be a 1:1 mapping or a more complex one.

Also, two or more databases 125 can be analyzed. In this case, the annotation process 220 provides a mapping of the data structures 200 of all databases 125 to the classes and properties in the data structure of the data source 120.

On the other hand, with the annotation process the specific user terminology 230 including second concepts 235 is analyzed and/or considered. Corresponding correlations are created for each second concept 235 of the user terminology 230 with at least one first concept 210 of the data source 120 and stored in the memory 118 (annotation process 240). In a more sophisticated system, correlations are created for each second concept 235 of the user terminology 230 with at least one query template including at least one first concept 210 of the data source 120 and stored as annotation rules in the memory 118.

The annotation processes 220, 240 may be performed manually or—if the data structure 200 of the database 125 has a certain or known structure-automatically. In case of an ORBIS® data base 125, automatic annotation processes 220, 240 are possible since the medical data is mainly stored in a hierarchical structure.

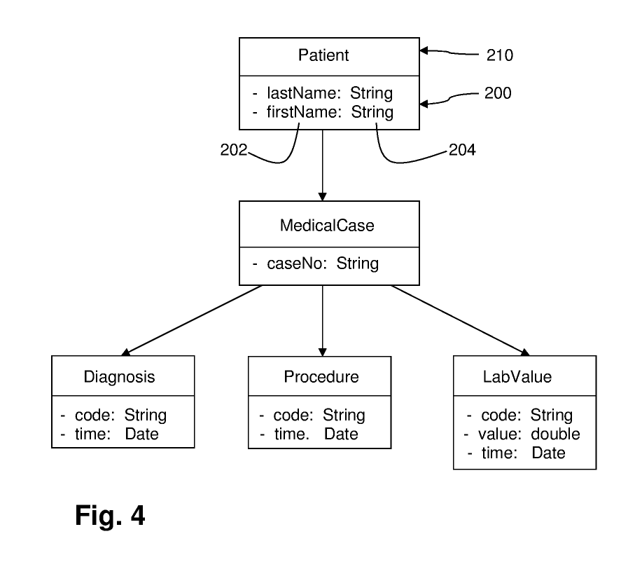

As illustrated in FIG. 4, at the top of a hierarchy there is for example the patient class. The first concept 210 of the data source 120 used here is “patient”. The data structure 200 of the database 125, e.g., includes the data elements 202 “lastName” and “firstName” each including corresponding parameter values 204. Each patient may have an arbitrary number of medical classes. A medical class may contain the data relevant for clinical decision support such as diagnoses, procedures, surgery information, lab data and any more.

By navigating this hierarchy from the root to the property that is to be annotated, a SPARQL query can be generated in a simple way. In case the query should not return data of all values found in the data source but, e.g., only values belonging to a specific patient or medical case, corresponding filters are generated. Here again, the hierarchical structure of ORBIS® makes it possible to generate these filters automatically.

With reference to FIGS. 1 and 3, executing a query is now explained in more detail.

First, the user inputs a semantic query 300 including predefined second concepts 230 of the specific user terminology 230 at the inputting means 130. This semantic query 300 is forwarded to the converter module 114 of the processing means 110 via the communication module 116. The converter module 114 automatically converts the received semantic query 300 into a database query 340 using SPARQL and including the first concepts 210 of the data source 120. When doing so, the converter module 114 reverts to the annotation data and annotation rules 320 stored in the memory 118.

Especially, the user may input the desired patient and/or medical case as parameters in the semantic query 300. The converter module 114 enters these parameter values into a corresponding SPARQL query template obtained from the memory 118.

The database query 340 is then forwarded to the search module 112 of the processing means 110 which then searches the connected data source 120 on the basis of the converted database query 340. The search module 112 retrieves corresponding search results from the connected data source 120.

This search result is forwarded back to the converter module 114 of the processing means 110. The converter module 114 automatically converts the search result into a search result 380 using the specific user terminology 230 including the second concepts 235. When doing so, the converter module 114 again reverts to the annotation data and annotation rules 320 stored in the memory 118. The converted search result 380 is then forwarded to the outputting means 140 via the communication module 116.

Although the database 125 may have a complex data structure 200 and/or data model, the system enables the user to input a semantic query 300 using a specific user terminology 230 and allows for outputting the search results 380 to the user using a specific user terminology 230. Especially, the user does not need to know the complex data structure 200 of the database 125 containing the information to be searched. The user even does not need to have knowledge about SPARQL and the first concepts 210 used in the data source 120. As a result, based on the two-step annotation process carried out in advance, the information system can execute semantic queries of a user in a very fast and efficient way so that the required processing power and time can be reduced saving energy and time.

Additional or alternative aspects and advantages of the invention are elucidated in the following.

A preferred embodiment of the present invention is preferably related to querying medical data from a complex clinical information system. However, it is applicable to other domains as well.

In the past, the information systems used within hospitals used to be mainly billing-driven. Nevertheless, during patient treatment a lot of medical data is collected and stored in these systems. Recently there is a trend in making this data available for clinical evaluations and to support medical staff at their daily work. Modern clinical information systems strive to provide their users clinical decision support, for instance they can
offer suggestions for an appropriate treatment,
analyze new data becoming available for a patient (e.g. lab values) in background based on rules and report anomalies,
check user input for plausibility, and/or
support users entering new data with reasonable default values or data already known to the system.

For all of these advanced applications reliable access to a patient's clinical data is crucial. So the complexity of an implementation is related to the way data can be accessed from the data structures used by the clinical information system. However, for various reasons clinical information systems tend to have very complex data models. E.g., the systems have been developed over a longer period of time, thus their data model has grown organically. Further, different modules have been developed by different development teams using their own specific conventions. Also, multiple technologies are in use. Moreover, in order to support the processes of their customers to a high degree, systems have to be customizable. This can lead even that far that users are allowed to define their own data structures. Because such structures are not under the control of the system, their concrete semantic meaning is not known per se.

To allow processing of complex data based on its semantic meaning, the present invention preferably uses a technological approach referred to as the Semantic Web. Part of this technology is SPARQL, a standardized query language for semantic data. Systems exposing their data through a SPARQL endpoint can be queried in a generic way. However, this is only part of a solution as queries have to be formulated in terms of the data model used by the system; so in order to query data, still the (complex) underlying data model of the system in question has to be known.

In order to address this specific problem, the invention proposes a way to query data independently from its concrete storage structures, but based on its semantic meaning. To this purpose, another part of the Semantic Web technology suite is used: terminologies. A terminology lists the terms (also named “concepts”) used within a specific domain and assigns a meaning to them. By associating an element of the data model of a clinical information system with a term from a terminology—a process referred to as annotation—, it can be assigned a meaning. For the medical domain there are already multiple terminologies which can be used for this purpose, like SNOMED CT, LOINC, or ICD.

As a result, annotated data can be easily accessed by applications offering clinical decision support. Provided that a query service is in place, those applications do not have to know where and how the data they require is stored, but can just query for specific terminology concepts. This effectively “hides” the actual complexity of the underlying data model.

To enable this approach, a mechanism to maintain annotation data for the data structures of an information system is proposed. Preferably, so-called knowledge engineers define the meaning of the system's data model elements and create annotation data. A query service accesses the annotation data created this way and translates it to queries on actual physical data structures.

In summary, the invention preferably relates an approach for assigning semantic meaning to elements of a complex data model. The assignment method is optimized for the execution of semantic queries. In an according method or system:
semantic concepts are associated with specific entities of a data model,
queries for semantic concepts are directly translated into SPARQL queries, and
the SPARQL queries are then executed on a SPARQL endpoint offered by the information system to be queried.

Preferably, the present invention defines an efficient way for storing annotation data which makes the generation of queries on the underlying data structures straight-forward. The preferred basic idea is to use special SPARQL query templates for assigning concepts from a terminology to data model elements of the information system. When queried for a specific concept, the query service retrieves the SPARQL templates associated with the concept in question, fills in current parameters, and executes them on the SPARQL endpoint offered by the system (the availability of such a SPARQL endpoint is a preferred pre-condition). This is described in more detail below.

A preferred embodiment of the invention preferably assumes that the system to be queried provides a SPARQL endpoint exposing all data of interest. The data model the SPARQL endpoint is built on may be arbitrarily complex; however, due to the inherent structure of SPARQL, the data is described in terms of classes and properties. The implementation of the SPARQL endpoint already has to provide a mapping from elements of the system's data model to classes or properties in the endpoint's model—this can be a 1:1 mapping or a more complex one.

It is possible to formulate SPARQL queries in a way that the result set contains only data from specific classes or even only a specific property value of a specific class. This basically means that the query selects a single element of the data model. By associating such a SPARQL query with a concept from a terminology, annotation of the corresponding data model element is effectively established. Annotation data maintained in this way not only transports the information that a certain data model has a specific semantic meaning but at the same time also provides the information necessary for querying the data stored for this element.

So, a basic approach of the invention relates to the use of SPARQL for referencing the data model elements to be annotated and for serving as input for a query service for the execution of semantic queries.

SPARQL queries referencing specific data model elements can either be created manually or-if the data model of the system to be queried has a certain structure—automatically generated. For ORBIS®, the system in which the invention is preferably implemented, automatic SPARQL query generation is possible. Here, medical data is mainly stored in a hierarchical structure. At the top of the hierarchy is the patient class. Each patient has an arbitrary number of medical cases. A medical case contains the data relevant for clinical decision support, such as diagnoses, procedures, surgery information, lab data and many more.

By navigating this hierarchy from the root to the property that is to be annotated, a SPARQL query of the following generic structure (in pseudo code) can be generated—here using the code of a lab value as example:

Start with Patient ?pat
?pat hasMedicalCase ?case
?case hasLabValue ?lab
?lab hasPropertyCode ?code
FILTER(?patID = $paramPatID, ?caseID = $paramCaseID)

Because the query should not return data of all values found in the database, but only values belonging to a specific patient or medical case, corresponding filters are generated. Here again the hierarchical structure of the data model makes it possible to generate these filters automatically. At query execution time the IDs of the desired patient and/or medical case are provided as parameters by the caller. The query service can enter these values in the generated filter condition. Therefore, the SPARQL used to define annotation data is actually a template rather than a valid SPARQL query; it becomes an executable query by inserting parameter values.

Preferably, the implementation of a semantic query service works as follows:

The service expects as input a unique identifier of a semantic concept whose data is to be retrieved. (It is possible to support multiple terminologies; in this case, a combination of terminology code and concept identifier can be used.) In addition, further filter parameters like a patient ID or medical case ID can be passed in.

The service consults its annotation information to retrieve the SPARQL template(s) associated with the concept to be queried.

In the SPARQL parameters are replaced by the current values passed by the caller.

The resulting SPARQL query is sent to the system's SPARQL endpoint.

Results are returned to the caller.

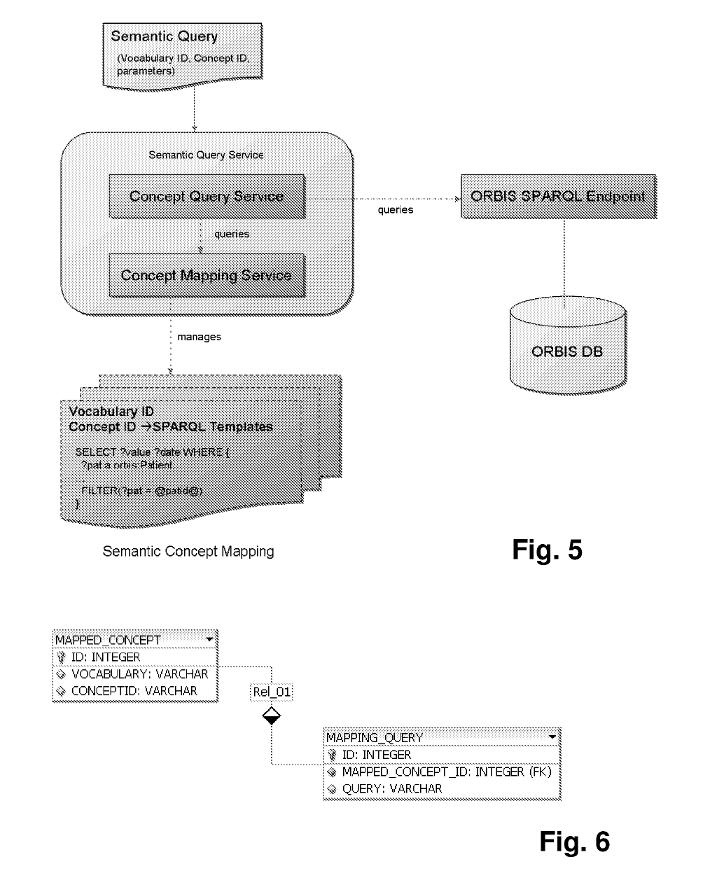

The diagram of FIG. 5 shows the high-level architecture of such a concept query service using ORBIS® as a concrete example. The figure also shows a Concept Mapping Service which is responsible for maintaining annotation data; it can also be accessed by an annotation editor tool. The ORBIS® SPARQL endpoint can execute SPARQL queries on an ORBIS® database.

Based on this description, annotation data can be stored in the following structure, for instance in a relational database, as illustrated in FIG. 6.

It has to be noted that there is a 1:n relation between the concept and the SPARQL query. This is due to the fact that the data model of the system to be queried can have some redundancy in its data structures, i.e. it contains multiple elements with the same semantic meaning in different physical storage structures. In this case, the data of all these elements has to be retrieved. This can be done by executing all SPARQL queries obtained for the current concept one by one and combining the result sets produced.

In distinction to the prior art, where no standard way or format for associating concepts from an external terminology with elements of a data model is known, the present invention defines a practical method how this can be achieved and which also simplifies the implementation of a service for querying data assigned to these concepts. The invention can be applied to all systems providing a SPARQL endpoint for data access, giving elements of the model the system operates on a semantic meaning.

1-9. (canceled)

10. A method for preparing a system for searching databases, the method comprising the steps of:
analyzing a data structure of a database containing information to be searched;
creating a data source that stores the information contained in the database in an RDF compatible format using first concepts;
analyzing a specific user terminology including second concepts;
creating correlations for each of the second concepts with at least one of the first concepts; and
storing the created correlations as annotation data in a memory.

11. The method according to claim 10, further comprising the steps of:
creating correlations for each of the second concepts with at least one query template including at least one of the first concepts; and
storing the created correlations as annotation rules in the memory.

12. The method according to claim 10, further comprising the steps of:
analyzing data structures of a second database including information to be searched; and
storing in the data source the information of the database and the second database in the RDF compatible format and using the first concepts.

13. The method according to claim 10, further comprising the step of:
analyzing at least two different specific user terminologies including the second concepts.

14. A medical information system for executing queries of a connected data source that stores information in an RDF compatible format and uses first concepts, the medical information system comprising:
an input that receives a semantic query from a user, the semantic query including second concepts having a specific user terminology;
a processor including a converter that converts the semantic query received from the input into a database query using query language adapted for the RDF compatible format and including the first concepts, the processor configured or programmed to search the connected data source by executing the database query; and
an output that outputs search results retrieved from the connected data source by the processor.

15. The medical information system according to claim 14, wherein the processor includes a memory that stores predefined annotation data which correlate each of the second concepts with at least one of the first concepts.

16. The medical information system according to claim 14, wherein the processor includes a memory that stores predefined annotation rules which correlate each of the second concepts with at least one query template including at least one of the first concepts.

17. The medical information system according to claim 14, wherein the processor includes a converter that converts the search results retrieved from the connected data source including the first concepts into a search result format including the second concepts.

18. A method for executing queries of a connected data source storing information in an RDF compatible format and using first concepts, the method comprising the steps of:
receiving a semantic query from a user, the semantic query including second concepts having a specific user terminology;
automatically converting the received semantic query into a database query using query language adapted for the RDF compatible format and including the first concepts;
searching the connected data source by executing the database query; and
outputting search results retrieved from the connected data source.

19. The method according to claim 10, wherein the system is a medical information system.
